(19) United States
(12) Patent Application Publication
(10) Pub. No.: US 2013/0009885 A1
(43) Pub. Date: Jan. 10, 2013

(54) TOUCH CONTROL SENSING APPARATUS AND METHOD THEREOF

(75) Inventor: Chien Yu CHAN, Hsinchu City (TW)

(73) Assignee: RAYDIUM SEMICONDUCTOR CORPORATION, Hsinchu (TW)

(21) Appl. No.: 13/241,581

(22) Filed: Sep. 23, 2011

(30) Foreign Application Priority Data
Jul. 7, 2011 (TW) 100123988

(51) Int. Cl. G06F 3/041

(52) U.S. Cl. 345/173

(57) ABSTRACT

A touch control sensing apparatus comprises a logic control module configured to generate a plurality of control signals, a driving sensing control module having a parallel sensing control unit coupled to the logic control module, a signal comparing module having at least one amplifier coupled to the logic control module, a parallel to serial control module coupled to the logic control module, and an analog digital convertor coupled between the logic control module and the parallel to serial control module.

### BACKGROUND OF THE INVENTION

1. Technical Field

The present disclosure relates to a touch control sensing apparatus, and in particular, to a touch control sensing apparatus that is able to correctly determine a boundary sensing voltage.

2. Background

Due to rapid developments in technology, the TFT LCD has gradually replaced the conventional display and is now applied in a wide range of electronic devices such as televisions, flat-panel displays, display of mobile phones, and flat-panel computers. For TFT LCD units with touch control function, the touch sensing controller is an important component and directly affects the display quality of the TFT LCD.

The conventional capacitive touch control LCD includes a display panel, an ITO sensor and a touch control chip. The ITO sensor includes a plurality of sensing lines and a plurality of driving lines. The touch control chip includes a plurality of pins.

The plurality of sensing lines respectively couple to the plurality of pins. When one of the plurality of driving lines transmits a driving pulse with a small couple voltage to one of the plurality of sensing lines, the touch control chip senses the couple voltage and determines whether the ITO sensor has been touched based on the strength of the couple voltage.

The quality of the touch control apparatus depends on the manufacturing yield. However, higher manufacturing yield of the ITO sensor corresponds to greater manufacturing cost. Moreover, the ITO sensor is the most expensive element in the touch control sensing apparatus. In practical operation, due to the couple voltage being extremely small, an ITO sensor of low quality will not be able to correctly sense the couple voltage or will sense the couple voltage with slight inaccuracy which will reduce the touch control quality. Additionally, even though the value of the couple voltage with slight inaccuracy may still be within the sensing range, the inaccuracy of the couple voltage will be increased by the amplifying process in the amplifying module.

Subsequently, the couple voltage with inaccuracy, which is an analog voltage, is converted to a digital voltage by the analog/digital converting module. Next, the logic control module will receive the digital voltage, resulting in an inaccurate touch control sensing.

It can be seen that the conventional touch control sensing apparatus cannot correctly determine the touch control signal, which adversely affects the touch control quality of the touch control panel.

In order to resolve the shortcomings of the conventional touch control sensing apparatus, the present invention provides a touch control sensing apparatus and method thereof that improves the touch control quality of the touch control panel.

### SUMMARY

The present invention discloses a touch control sensing apparatus and method thereof to solve the sensing problems of the conventional boundary touch control signal.

In accordance with one embodiment of the present invention, a touch control sensing apparatus comprises a logic control module configured to generate a plurality of control signals, a driving sensing control module coupled to the logic control module comprising a parallel sensing control unit, a signal comparison module coupled to the logic control module and the driving sensing control module comprising at least one amplifier, a storage control module coupled to the signal comparison module and the logic control module acting by taking into consideration a storage control signal of the logic control module, a parallel timing control module coupled to the logic control module and the storage control module acting by taking consideration a parallel timing control signal of the logic control signal, and an analog/digital converter coupled to the logic control module and the parallel timing control module configured to transmit a digital signal to the logic control module. Each of the plurality of control signals has different control timing. The driving sensing control module acts based on a driving sensing control signal of the logic control module. The signal comparison module acts based on a signal comparison control signal.

In accordance with one embodiment of the present invention, a method of touch control sensing comprises the steps of receiving a plurality of sensing voltages from a plurality of sensing lines, calculating a voltage difference between two adjacent sensing lines, outputting an amplified first analog data by taking into consideration the voltage difference, calculating a voltage difference between a boundary sensing voltage and a reference voltage, outputting an amplified second analog data by taking into consideration the voltage difference between a boundary sensing voltage and a reference voltage, and converting the first analog data and the second analog data to a first digital data and a second digital data.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention are illustrated with the following description and upon reference to the accompanying drawings in which:

FIG. 1 schematically illustrates one embodiment of the current invention indicating a touch control sensing apparatus sensing touch control motions from a plurality of touch control points of a touch control panel;

FIG. 2 schematically illustrates the plurality of pins and the driving sensing module;

FIG. 3 schematically illustrates one embodiment of the present invention indicating circuits of the touch control sensing apparatus; and

FIG. 4 shows a flow chart of one embodiment of the present invention.

### DETAILED DESCRIPTION

The present invention discloses a touch control sensing apparatus and method thereof to solve the sensing problems of the conventional boundary touch control signal.

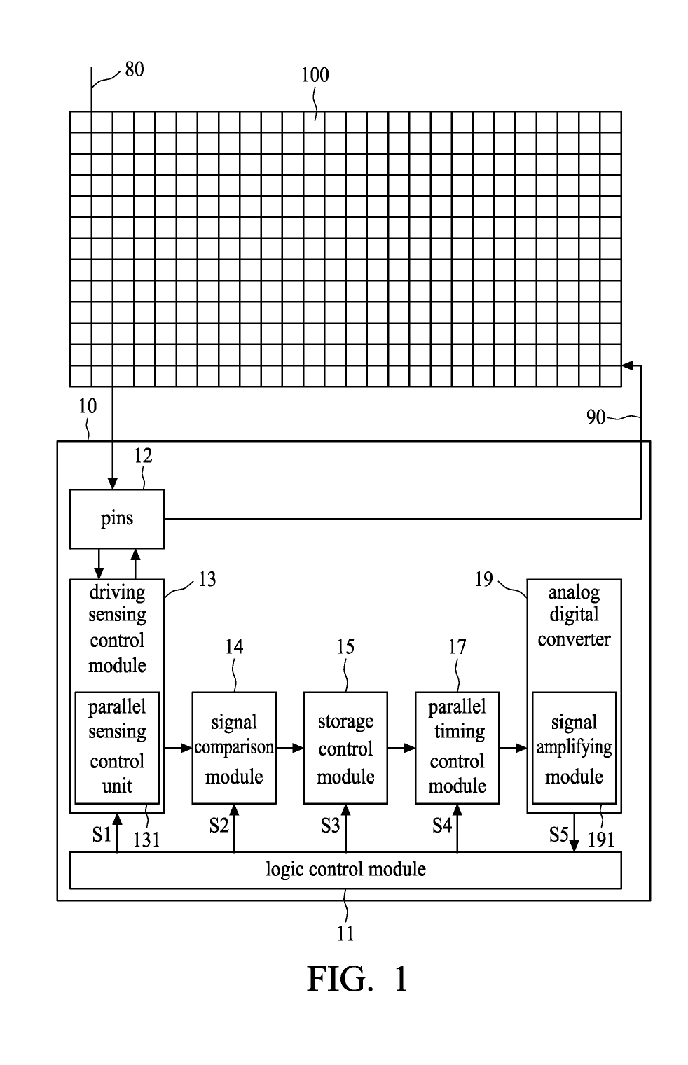

FIG. 1 schematically illustrates one embodiment of the current invention indicating a touch control sensing apparatus sensing touch control motions from a plurality of touch control points of a touch control panel. The touch control panel includes a conductive film sensor 100 and a touch control sensing apparatus 10. The touch control sensing apparatus 10 includes a logic control module 11, a driving sensing control module 13, a signal comparison module 14, a storage control module 15, a parallel timing control module 17, and an analog/digital converter 19. The analog/digital converter 19 is coupled to the parallel timing control module 17 and is configured to transmit a digital control signal S5 to the logic control module 11. The said modules are respectively coupled to the logic control module 11, wherein the touch control sensing apparatus further comprises a plurality of pins 12.

The signal comparison module 14 includes at least one amplifier, wherein the plurality of pins 12 are divided into a plurality of pin groups, and each of the plurality of pin groups corresponds to the at least one amplifier. The driving sensing control module 13 includes a parallel sensing control unit 131 and the analog/digital converter 19 includes a signal amplifying module 191.

The driving sensing control module 13 is coupled between the plurality of pins 12 and the signal comparison module 14. The storage control module 15 is coupled between the signal comparison module 14 and the parallel timing control module 17.

The logic control module 11 is configured to generate a plurality of control signals, wherein each of the plurality of control signals has different control timing. The plurality of control signals includes a driving sensing control signal S1, a signal comparison control signal S2, a storage control signal S3, and a parallel timing control signal S4. The driving sensing control module 13 acts based on the driving sensing control signal S1. The signal comparison module 14 acts based on the signal comparison control signal S2. The storage control module 15 acts based on the storage control signal S3. The parallel timing control module 17 acts based on the parallel timing control signal S4.

As shown in FIG. 1, the conductive film sensor 100 includes a plurality of vertical sensing lines 80 and a plurality of parallel driving lines 90. The touch control sensing apparatus 10 can operate the plurality of vertical sensing lines 80 as a plurality of driving lines. In the current embodiment, each of the plurality of pins 12 can respectively transmit a driving signal to each of the plurality of driving lines 90 and sense a plurality of analog data from the plurality of sensing lines 80.

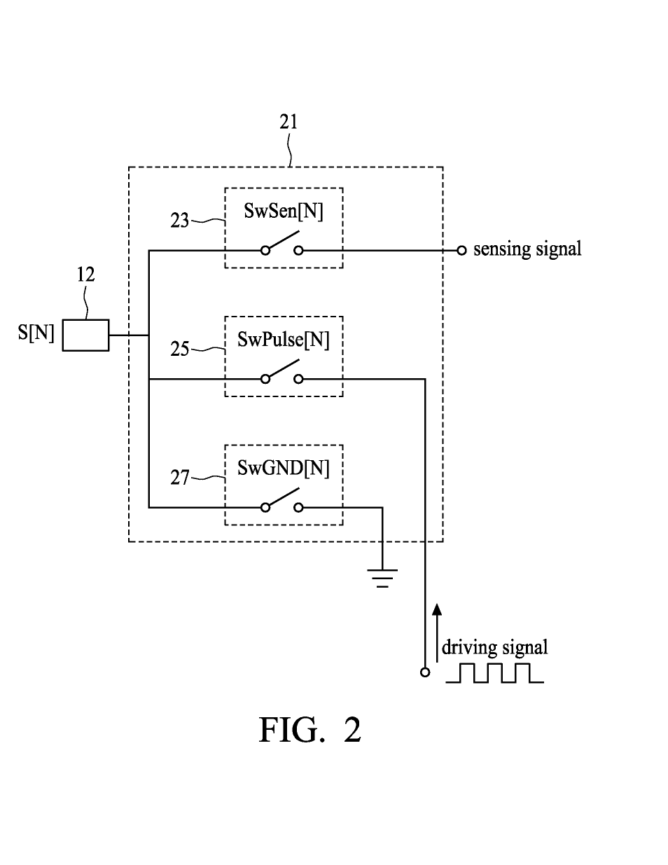

FIG. 2 schematically illustrates the plurality of pins and the driving sensing module. As shown in FIG. 2, the driving sensing module 21 includes a sensing switch 23, a driving switch, and a ground switch 27, wherein all of the switches respectively connect to one of the plurality of pins. Therefore, the plurality of pins perform functions of driving, sensing, grounding and floating.

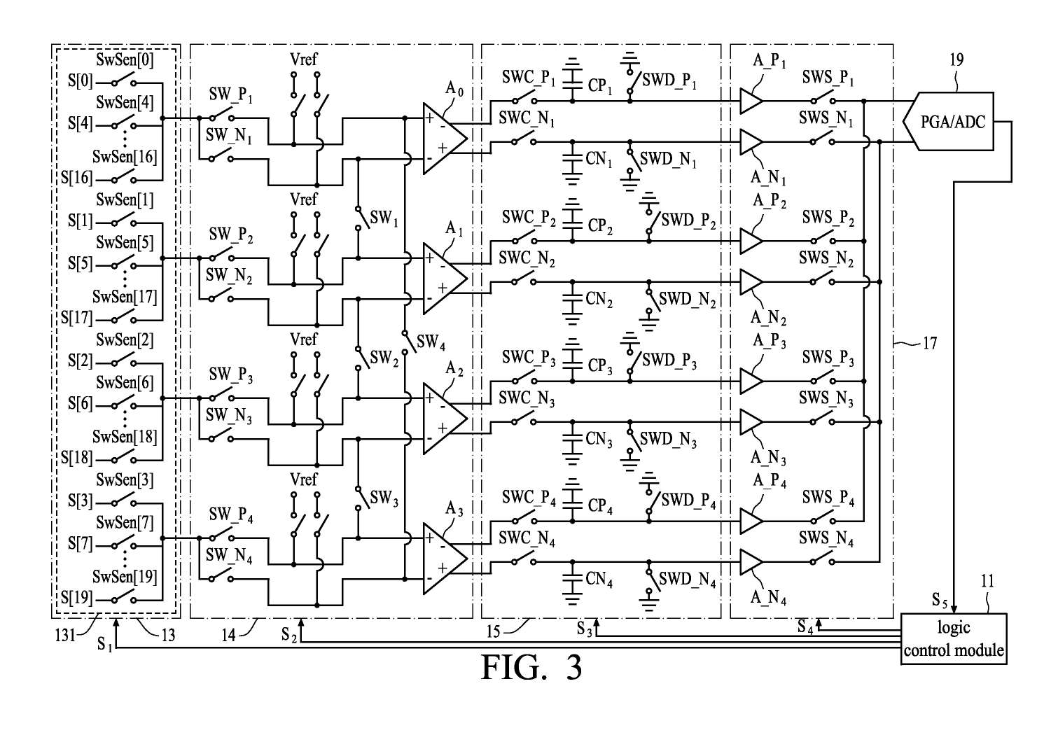

FIG. 3 schematically illustrates one embodiment of the present invention indicating circuits of the touch control sensing apparatus. In FIG. 3, four amplifiers A0 to A3 disposed in the signal comparison module 14 and sensing twenty sensing voltages from twenty pins S[0] to S[19] are presented as an example but the embodiment is not limited to the example. As shown in FIG. 3, the driving sensing control module 13 includes the parallel sensing control unit 131. Referring to FIG. 2, the sensing switch 23 of each of the plurality of pins 12 is disposed in the parallel sensing control unit 131.

As shown in FIG. 3, the twenty switches are allocated to the four amplifiers in the following order. The sensing switch SwSen [0] is allocated to the amplifier A1, the sensing switch SwSen [1] is allocated to the amplifier A2, the sensing switch SwSen [2] is allocated to the amplifier A3, and the sensing switch SwSen [3] is allocated to the amplifier A4. Therefore, the four amplifiers can receive twenty sensed analog signals which comprise twenty sensing voltages, calculate a voltage difference between adjacent pairs of sensing lines, and then output a voltage data by taking into consideration the voltage difference to a corresponding capacitor of the storage control module 15. The corresponding capacitor of the storage control module 15 is configured to store the voltage data.

For example, the amplifier A0 calculates the sensed voltage from the pin S[0] and the sensed voltage from the pin S[1], and transmits a calculated voltage data to a corresponding capacitor of the storage control module 15. Later, the amplifier A1 calculates the sensed voltage from the pin S[1] and the sensed voltage from the pin S[2] and transmits a calculated voltage data to a corresponding capacitor of the storage control module 15.

The method continues calculating a difference between adjacent pairs of sensing lines until a boundary sensing voltage is detected. The boundary sensing voltage is a sensing voltage sensed by a last sensing line. Therefore, the boundary sensing voltage must be compared to a reference voltage in order to get a voltage difference. In the current example, the boundary sensing voltage is the sensing voltage sensed by the pin S[19].

Thus, the sensing voltage sensed by the pin S[19] must be compared to a reference voltage Vref to derive a voltage data for transmission to and storage in a corresponding capacitor in the storage control module 15. Later, the storage control module 15 transmits the voltage data stored in the capacitor to the parallel timing control module 17.

As shown in FIG. 3, each of the capacitors in the storage control module further includes a corresponding discharge switch configured to release the voltage data in the capacitor which has been transferred to the parallel timing control 17. The parallel timing control module 17 then transmits an analog signal based on the parallel timing control signal S4 to the analog/digital converter 19. The analog/digital converter transmits a digital signal to the logic control module 11.

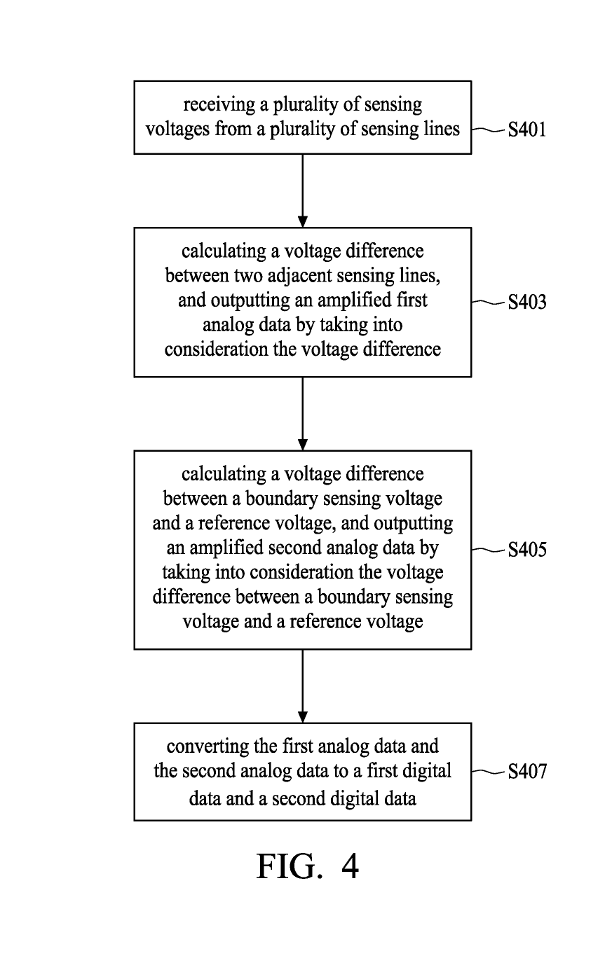

FIG. 4 shows a flow chart of one embodiment of the present invention. As shown in FIG. 4, in step S401 a plurality of sensing voltages are received from a plurality of sensing lines; in step S403 a voltage difference between two adjacent sensing lines is calculated and an amplified first analog data is output based on the voltage difference; in step S405 a voltage difference between a boundary sensing voltage and a reference voltage is calculated and an amplified second analog data is output based on the voltage difference between a boundary sensing voltage and a reference voltage; and in step S407 the first analog data and the second analog data are converted to a first digital data and a second digital data.

Although the present invention and its objectives have been described in detail, it should be understood that various changes, substitutions and alterations can be made herein without departing from the spirit and scope of the invention as defined by the appended claims. For example, many of the processes discussed above can be implemented using different methodologies, replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A touch sensing control apparatus, comprising:
a logic control module configured to generate a plurality of control signals, wherein each of the plurality of control signals has different control timing;
a driving sensing control module coupled to the logic control module comprising a parallel sensing control unit, wherein the driving sensing control module acts based on a driving sensing control signal of the logic control module;
a signal comparison module coupled to the logic control module and the driving sensing control module comprising at least one amplifier, wherein the signal comparison module acts based on a signal comparison control signal;
a storage control module, coupled to the signal comparison module and the logic control module, wherein the storage control module acts based on a storage control signal of the logic control module;
a parallel timing control module, coupled to the logic control module and the storage control module, wherein the parallel timing control module acts based on a parallel timing control signal of the logic control signal; and
an analog/digital converter, coupled to the logic control module and the parallel timing control module, wherein the analog/digital converter is configured to transmit a digital signal to the logic control module.

2. The touch control sensing apparatus of claim 1, wherein the storage control module further comprises a plurality of capacitors configured to store a voltage data from the signal comparison module.

3. The touch control sensing apparatus of claim 1, further comprising a plurality of pins configured to couple the driving sensing control module.

4. The touch control sensing apparatus of claim 3, wherein the plurality of pins perform functions of driving, sensing, ground and floating.

5. The touch control sensing apparatus of claim 4, wherein the plurality of pins are divided into a plurality of pin groups, and each of the plurality of pin groups corresponds to the at least one amplifier.

6. The touch control sensing apparatus of claim 1, wherein the at least one amplifier is a differential amplifier having two output terminals.

7. A method of touch control sensing, comprising:
receiving a plurality of sensing voltages from a plurality of sensing lines;
calculating a voltage difference between two adjacent sensing lines, and outputting an amplified first analog data by taking into consideration the voltage difference;
calculating a voltage difference between a boundary sensing voltage and a reference voltage, and outputting an amplified second analog data by taking into consideration the voltage difference between a boundary sensing voltage and a reference voltage; and
converting the first analog data and the second analog data to a first digital data and a second digital data.

8. The method of claim 7, wherein the boundary sensing voltage is a last received sensing voltage.
